(19) United States
(12) Patent Application Publication
(10) Pub. No.: US 2023/0287157 A1
(43) Pub. Date: Sep. 14, 2023

(54) Ethylene-Based Polymer Composition with Multifunctional Branching Agent and Process for Producing Same

(71) Applicant: Dow Global Technologies LLC, Midland, WI (US)

(72) Inventors: Ivan A. Konstantinov, Lake Jackson, TX (US); Arkady L. Krasovskiy, Lake Jackson, TX (US); Sean W. Ewart, Lake Jackson, TX (US); Sarat Munjal, Lake Jackson, TX (US); Michael W. Tilston, Lake Jackson, TX (US)

(21) Appl. No.: 18/007,258

(22) PCT Filed: Jul. 27, 2021
(86) PCT No.: PCT/US2021/070979

§ 371 Date: Jan. 27, 2023

Related U.S. Application Data
(60) Provisional application No. 63/057,937, filed on Jul. 29, 2020.

(51) Int. Cl. C08F 210/02; C08F 2/01

(52) U.S. Cl. CPC C08F 210/02; C08F 2/01

(57) ABSTRACT

The present disclosure provides a process. In an embodiment, the process includes providing a multifunctional branching agent (MFBA). The MFBA has A) three or more carbon-carbon double bonds with the provisos (1) that the MFBA is not a polymer of butadiene, and (2) the MFBA does not contain an acrylate group or a methacrylate group. The MFBA has B) a total reactivity, R, greater than 3 and less than 40, (3<R<40) wherein R is determined with the following formula (I): wherein j=index of summation, p=the number of different types of carbon-carbon double bonds j in the molecule, nⱼ=the number of each carbon-carbon double bond of type j in the molecule, and r_{1,j}=the relative reactivity ratio (RRR) of ethylene to the carbon-carbon double bond j. The process includes reacting the MFBA with ethylene under polymerization conditions and forming an ethylene-based polymer composition composed of units of ethylene and units of the MFBA. The present disclosure also provides the ethylene-based polymer composition resulting from the process.

$$R = {\sum }_{{j = 1}^{}}^{p} \frac{{n}_{j}}{{r}_{1 , j}} = \frac{{n}_{1}}{{t}_{1 , 1}} + \frac{{n}_{2}}{{t}_{1 , 2}} + \frac{{n}_{3}}{{t}_{1 , 3}} + … \qquad formula ( I )$$

### BACKGROUND

The level of branching in an ethylene-based polymer, such as low density polyethylene (LDPE) for example, is due predominantly to the reactor design (autoclave or tubular) and the polymerization conditions used to make the LDPE. The level of branching is also correlated directly with the melt strength of the final polymer. Known are branching agents for increasing the level of branching in an LDPE. However, the process conditions required to achieve a modified LDPE with a high level of branching, often result in a final product with a lower crystallinity, and with a higher content of a low molecular weight extractable fraction.

Thus, the art recognizes the on-going need for LDPE with increased melt strength vis-à-vis increased branching levels, the LDPE prepared under polymerization conditions that maintain good polymer properties.

### SUMMARY

The present disclosure provides a process. In an embodiment, the process includes providing a multifunctional branching agent (MFBA). The MFBA has A) three or more carbon-carbon double bonds with the provisos (1) that the MFBA is not a polymer of butadiene, and (2) the MFBA does not contain an acrylate group or a methacrylate group. The MFBA has B) a total reactivity, R, greater than 3 and less than 40, (3<R<40) wherein R is determined with the following formula (I):

$$R = {\sum }_{{j = 1}^{}}^{p} \frac{{n}_{j}}{{r}_{1 , j}} = \frac{{n}_{1}}{{t}_{1 , 1}} + \frac{{n}_{2}}{{t}_{1 , 2}} + \frac{{n}_{3}}{{t}_{1 , 3}} + … \qquad formula ( I )$$

wherein

j=index of summation,

p=the number of different types carbon-carbon double bonds j in the molecule,

nⱼ=the number of each carbon-carbon double bond of type j in the molecule, and

r_{1,j}=the relative reactivity ratio (RRR) of ethylene to the carbon-carbon double bond j. The process includes reacting the MFBA with ethylene under polymerization conditions and forming an ethylene-based polymer composition comprising units of ethylene and units of the MFBA.

The present disclosure also provides the ethylene-based polymer composition resulting from the process. In an embodiment, the ethylene-based polymer composition includes (i) units of ethylene; and (ii) units of a multifunctional branching agent (MFBA). The MFBA has

(A) three or more carbon-carbon double bonds with the provisos (1) that the MFBA is not a polymer of butadiene, and (2) the MFBA does not contain an acrylate group or a methacrylate group. The MFBA has (B) a total reactivity, R, greater than 3 and less than 40, (3<R<40) wherein R is determined with the following formula (I)

$$R = {\sum }_{{j = 1}^{}}^{p} \frac{{n}_{j}}{{r}_{1 , j}} = \frac{{n}_{1}}{{t}_{1 , 1}} + \frac{{n}_{2}}{{t}_{1 , 2}} + \frac{{n}_{3}}{{t}_{1 , 3}} + … \qquad formula ( I )$$

wherein

j=index of summation,

p=the number of different types of carbon-carbon double bonds in the MFBA,

nⱼ=the number of each carbon-carbon double bond of type j in the molecule, and

r_{1,j}=the relative reactivity ratio (RRR) of ethylene to the carbon-carbon double bond j.

### BRIEF DESCRIPTION OF THE DRAWINGS

FIG. 1 shows the chemical structure of a multi-functional branching agent in accordance with an embodiment of the present disclosure.

FIG. 2 shows the chemical structure of a multi-functional branching agent in accordance with an embodiment of the present disclosure.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes subranges of 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

An “alkane” is a saturated hydrocarbon. An “alkyl” (or “alkyl group”) is an alkane having a valence (typically univalent).

An “alkene” is a hydrocarbon containing a carbon-carbon double bond. An “alkenyl” (or “alkenyl group”) is an alkene having a valence (typically univalent)

The term “allyl” (or “allyl group”) is a univalent unsaturated C3H5 hydrocarbon. In other words, an allyl group is propene minus one hydrogen atom.

The terms “blend” or “polymer blend,” as used herein, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The term “ethylene-based polymer composition,” as used herein, refers to a composition that includes, in polymerized form, more than 50 wt %, or a majority amount, of ethylene, based on the weight of the polymer, and, optionally, may comprise at least one comonomer or other molecule.

The term “ethylene monomer,” as used herein, refers to a chemical unit having two carbon atoms with a double bond therebetween, and each carbon bonded to two hydrogen atoms, wherein the chemical unit polymerizes with other such chemical units to form an ethylene-based polymer composition. A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure.

The term “low density polyethylene,” (or LDPE) as used herein, refers to a polyethylene having a density from 0.910 g/cc to less than 0.940 g/cc, or from 0.918 g/cc to 0.930 g/cc, and long chain branches with a broad molecular weight distribution (MWD)—i.e., “broad MWD” from 4.0 to 20.0.

An “olefin” is an unsaturated, aliphatic hydrocarbon having a carbon-carbon double bond.

The term “phenyl” (or “phenyl group”) is a C₆H₅ aromatic hydrocarbon ring having a valence (typically univalent).

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/a-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

### TEST METHODS

Density is measured in accordance with ASTM D792, Method B. Results are reported in grams per cubic centimeter (g/cc).

### Melt Index

The term, “melt index,” (or “MI,” or “I2”) as used herein, refers to the measure of how easily a thermoplastic polymer flows when in a melted state. Melt index, or I₂, is measured in accordance by ASTM D1238, Condition 190° C./2.16 kg, and is reported in grams eluted per 10 minutes (g/10 min). The I₁₀ is measured in accordance with ASTM D1238, Condition 190° C./10 kg, and is reported in grams eluted per 10 minutes (g/10 min). Melt index ratio (I₁₀/I₂) is measured in accordance with ASTM D1238 at a temperature of 190° C. taking the ratio of values obtained at 10 kg and 2.16 kg.

### Melt Strength

The term “melt strength,” as used herein, refers to the measure of the maximum tension applied to a polymer in a melted state, before the polymer breaks. Melt strength is measured at 190° C. using a Göettfert Rheotens 71.97 (Göettfert Inc.; Rock Hill, SC). The melted sample (from 25 to 50 grams) is fed with a Goettfert Rheotester 2000 capillary rheometer, equipped with a flat entrance angle (180 degrees), and of length of 30 mm and diameter of 2 mm. The sample is fed into the barrel (L=300 mm, Diameter=12 mm), compressed, and allowed to melt for 10 minutes, before being extruded at a constant piston speed of 0.265 mm/s, which corresponds to a wall shear rate of 38.2 s⁻¹ at the given die diameter. The extrudate passes through the wheels of the Rheotens, located at 100 mm below the die exit, and is pulled by the wheels downward, at an acceleration rate of 2.4 millimeters per square second (mm/s²). The force (measured in centiNewtons, cN) exerted on the wheels is recorded as a function of the velocity of the wheels (in mm/s). Samples are repeated at least twice, until two curves of the force (in cN) as a function of strand velocity (in mm/s) superimpose, then the curve that had the highest velocity at the strand break is reported. Melt strength is reported as the plateau force before the strand breaks, in units of centi-newtons, cN.

### DETAILED DESCRIPTION

### 1. Process

The present disclosure provides a process. The process includes providing a multifunctional branching agent (MFBA) and reacting the MFBA with ethylene under polymerization conditions. The process includes forming an ethylene-based polymer composition comprising units of ethylene and units of the MFBA. The process includes providing, or otherwise selecting, a multifunctional branching agent (or “MFBA”). A “multifunctional branching agent,” as used herein, is a compound that meets, or otherwise fulfills, the following parameters (A) and (B) below:

A) three or more carbon-carbon double bonds with the provisos
(1) that the MFBA is not a polymer of butadiene, and
(2) the MFBA does not contain an acrylate group or a methacrylate group,

B) a total reactivity, R, greater than 3 and less than 40, (3<R<40) wherein R is determined with formula (I)

$$R = {\sum }_{{j = 1}^{}}^{p} \frac{{n}_{j}}{{r}_{1 , j}} = \frac{{n}_{1}}{{t}_{1 , 1}} + \frac{{n}_{2}}{{t}_{1 , 2}} + \frac{{n}_{3}}{{t}_{1 , 3}} + … \qquad formula ( I )$$

wherein

j is the index of summation,

p is the number of different types of carbon-carbon double bonds in the MFBA,

nⱼ is the number of each carbon-carbon double bond of type j in the molecule, and

r_{1,j} is the relative reactivity ratio (RRR) of ethylene to the carbon-carbon double bond j towards free radical propagation. In the context of formula (I), it is understood “is” is interchangeable with the equal sign, “=.”

The process includes providing, or otherwise selecting, an MFBA having (A) three or more carbon-carbon double bonds with the provisos (1) that the MFBA is not a polymer of butadiene, and (2) the MFBA does not contain an acrylate group or a methacrylate group. A “carbon-carbon double bond,” as used herein, has the Structure (I):

C═C Structure (I)

The MFBA has three or more carbon-carbon double bonds or from 3, or 5, or 10, to 20, or 30, or 50, or 100, or more carbon-carbon double bonds. In an embodiment, the MFBA has from 3 to 100 carbon-carbon double bonds, or from 5 to 50 carbon-carbon double bonds, or from 10 to 30 carbon-carbon double bonds.

A “polymer of butadiene,” as used herein, is a polymer with units of polymerized C₄H₆ having the Structure (II):

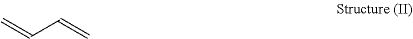

and/or a polymer having the Structure (III):

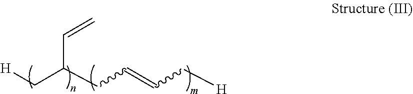

wherein the value for m is an integer from 1 to 100 and the value for n is an integer from 0 to 100. The present MFBA is void of, or otherwise excludes, “a polymer of butadiene.”

An “acrylate group or a methacrylate group,” as used herein, is a reactive group containing the Structure (IV) below:

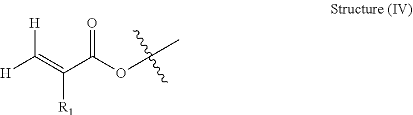

wherein R₁ is H or CH₃. Structure (IV) includes acrylates and methacrylates. The present MFBA is void of, or otherwise excludes, “an acrylate group or a methacrylate group.”

In addition to fulfilling (A) above, the multifunctional branching agent meets, or otherwise fulfills, parameter (B) a total reactivity, R, greater than 3 and less than 40, (3<R<40) wherein R is determined with formula (I)

$$R = {\sum }_{{j = 1}^{}}^{p} \frac{{n}_{j}}{{r}_{1 , j}} = \frac{{n}_{1}}{{t}_{1 , 1}} + \frac{{n}_{2}}{{t}_{1 , 2}} + \frac{{n}_{3}}{{t}_{1 , 3}} + … \qquad formula ( I )$$

wherein

j=index of summation,

p=the number of different types carbon-carbon double bonds in the MFBA,

nⱼ=the number of each carbon-carbon double bond of type j in the molecule, and

r_{1,j}=the relative reactivity ratio (RRR) of ethylene to the carbon-carbon double bond j towards free radical polymerization.

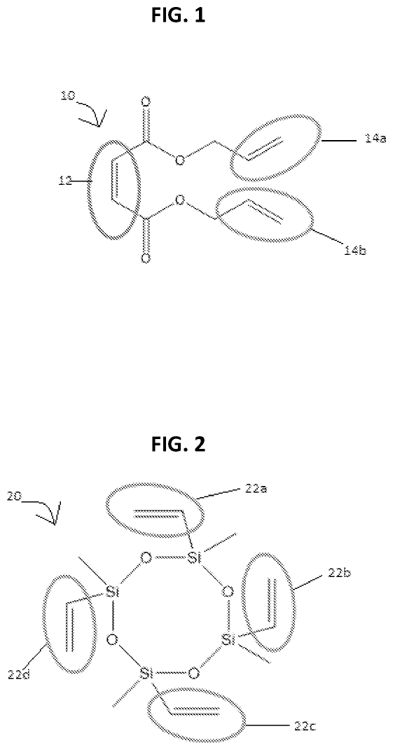

The term “j” is the index of summation (or the lower limit of summation, the number used to generate the first term in the series). The term “p” is the number of different types of C—C double bonds (carbon-carbon double bonds) present in the MFBA. FIG. 1 shows the structure of an MFBA, bisallyl maleate, denoted by reference numeral 10. Bisallyl maleate (10) has two different types of C—C double bonds. A first C—C double bond is shown at reference numeral 12. A second type of C—C double bond, a terminal double bond, is shown at reference numeral 14a and 14b. Although bisallyl maleate has three total C—C double bonds, the number of different types of bonds is 2, because the two terminal C—C bonds (reference numerals 14a, 14b) are the same type of C—C double bond, namely a terminal C—C double bond. For bis-allyl maleate, the value for “p” is 2.

FIG. 2 shows a nonlimiting example of another MFBA, 2,4,6,8-tetramethyl-2,4,6,8-tetravinyl-cyclotetrasiloxane (hereafter interchangeably referred to as “(D^{Vi})₄”) and denoted by reference numeral 20. (D^{Vi})₄ (reference numeral 20) has four C—C double bonds, 22a, 22b, 22c, and 22d. C—C double bond 22a, 22b, 22c, and 22d each is the same type of C—C double bond. Consequently, p=1 for (D^{Vi})₄.

In formula (I), the term “n” denotes the number of each type of double bond. For example, bisallyl maleate (reference numeral 10 shown in FIG. 1) one C—C double bond 12 for the C—C first double bond type and two terminal C—C double bonds 14a, 14b for the second C—C double bond type. By way of further example, (D^{Vi})₄ (reference numeral 20 in FIG. 2), has four C—C double bonds of the same type, 22a, 22b, 22c, and 22d.

Reactivity ratio is calculated as the relative reactivity of ethylene compared to the C—C double bond in question. The reactivity ratio can be measured experimentally by running experiments. Alternatively, the reactivity ratio can be calculated from quantum mechanics or it can be found in the reference by Mortimer and Ehrlich, Fundamentals of the Free-Radical Polymerization of Ethylene, Adv. Polymer Sci, Vol. 7, pp. 386-448 (1970) (hereafter interchangeably referred to as Mortimer), the contents of which are incorporated by reference herein. Table 1 below provides nonlimiting examples of reactivity ratios (relative to ethylene) for several reactive groups as determined by Mortimer.

Nonlimiting examples of reactive groups and respective reactivity ratios are provided in Table 1 below.

TABLE 1*

| Reactive group | Reactivity ratio |
|---|---|
| 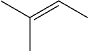 | 9.1 |
| 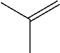 | 2.6 |
| 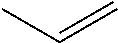 | 3.1 |
| 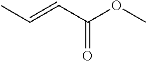 | 0.75 |
| 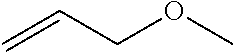 | 3.1 |
| 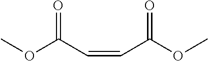 | 0.2 |
| 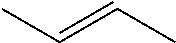 | 0.7 |
| 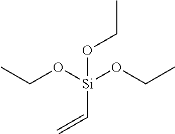 | 0.4 |

*See Mortimer

Table 2 below provides nonlimiting examples of suitable multifunctional branching agents and the calculation of R, total reactivity, using formula (I). Polymeric formulae are simplified to their respective repeat units.

TABLE 2

| | j = index of summation | |
|---|---|---|
| | p = number of different types of carbon- | |
| | carbon double bonds in the MFBA | |
| | nⱼ = number of each carbon-carbon double | |
| | bond of type j | |
| | r1,j = reactivity ratio of that group ethylene | |
| MFBA | to the carbon-carbon double bond j | Total reactivity, R |
| 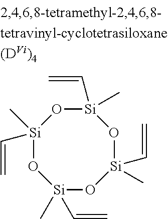 [SMILES: C=C[Si]1(C)O[Si](C)(C=C)O[Si](C)(C=C)O[Si](C)(C=C)O1] | p = 1 n₁ = 4, r_{1,1} = 0.4 | $R = \frac{4}{0.4} = 10$ |
| 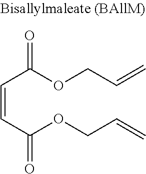 | p = 2 n₁ = 1, r_{1,1} = 0.2 n₂ = 2, r_{1,2} = 3.1 | $R = \frac{1}{0.2} + \frac{2}{3.1} = 5.6$ |
| 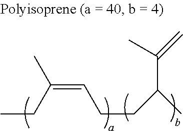 | p = 2 n₁ = 40, r_{1,1} = 9.1 n₂ = 4, r_{1,2} = 2.6 | $R = \frac{40}{9.1} + \frac{4}{2.6} = 5.9$ |
| 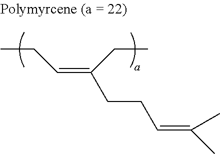 | p = 1 each a unit has 2 equivalent internal unsaturations (44) n₁ (total internal unsaturations) = 44 r_{1,1} = 9.1 | $R = \frac{44}{9.1} = 4.8$ |
| 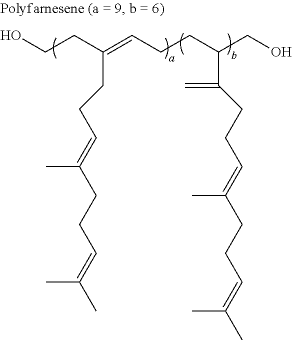 | p = 2 each a unit has 3 internal unsaturations (27) each b has 2 internal unsaturations (12) + 1 vinylidene unsaturation (6) n₁ (total internal unsaturations) = 39 r_{1,1} = 9.1 n₂ (total vinylidene unsaturations) = 6 r_{1,2} = 2.6 | $R = \frac{39}{9.1} + \frac{6}{2.6} = 6.6$ |

Table 3 below shows nonlimiting examples of compounds that do not fulfill parameters (A) and (B) and are not a “multifunctional branching agent” in accordance with the present disclosure. Primarily because R is less than 3 or R is greater than 40 and/or the total number or C—C double bonds in the molecule are less than 3 or because one or more of the C—C double bonds is an acrylate or a methacrylate.

TABLE 3
compounds that are not an MFBA

| | j = index of summation | | |
|---|---|---|---|
| | p = number of different | | |
| | types of carbon-carbon | | |
| | double bonds in the MFBA | | |
| | nⱼ = number of each | | |
| | carbon-carbon double | | |
| | bond of type j | | |
| | r1,j = reactivity ratio of | | |
| | that group ethylene to the | | Reason why |
| | carbon-carbon double | Total | compound is |
| Compound | bond j | reactivity, R | not an MFBA |
| 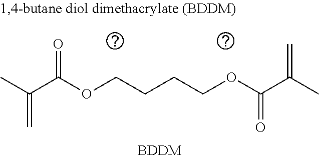 | p = 1, n₁ = 2, r_{1,1} = 0.02 | $R = \frac{2}{0.02} = 100$ | R > 40, contains acrylates, less than 3 C—C double bonds |
| 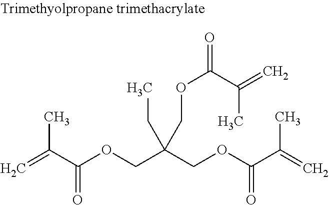 [SMILES: C=C(C)C(=O)OCC(CC)(COC(=O)C(=C)C)COC(=O)C(=C)C] | p = 1, n₁ = 3, r_{1,1} = 0.02 | $R = \frac{3}{0.02} = 150$ | R > 40, contains acrylates |
| 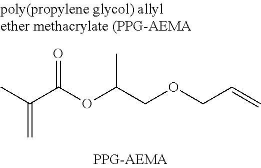 | p = 2 n₁ = 1, r_{1,1} = 0.02 n₂ = 1, r_{1,2} = 3.1 | $\begin{matrix}R = \frac{1}{0.02} + \frac{1}{3.1} \\ = 50.3\end{matrix}$ | R > 40, contains acrylates, less than 3 C—C double bonds |
| 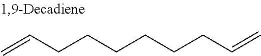 | p = 1 n₁ = 2, r_{1,1} = 3.1 | $R = \frac{2}{3.1} = 0.65$ | R < 3, less than 3 C—C double bonds |
| 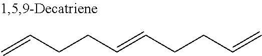 | p = 2 n₁ = 2, r_{1,1} = 3.2 n₂ = 1, r_{1,2} = 0.7 | $\begin{matrix}R = \frac{2}{3.1} + \frac{1}{0.7} \\ = 2.07\end{matrix}$ | R < 3 |

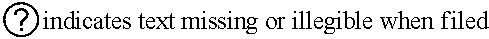

The process includes reacting the MFBA with ethylene under polymerization conditions. The term “polymerization conditions,” as used herein, includes free-radical initiated polymerization under high pressure (from 11,000 psig to 53,000 psig) and high temperature (from 200° C. to 350° C.), in a polymerization reactor.

In an embodiment, the MFBA is selected from (D^{Vi})₄, bisallylmaleate, polyisoprene, polymyrcene, polyfarnesene, and combinations thereof.

In an embodiment, the MFBA is (D^{Vi})₄.

In an embodiment, the MFBA is bisallylmaleate.

Reaction of the MFBA and ethylene under the polymerization conditions forms an ethylene-based polymer having units derived from ethylene and units derived from the MFBA, wherein the units of ethylene constitute a majority amount (wt %) of the monomers present in the polymer. In other words, the ethylene-based polymer includes ethylene monomer and MFBA comonomer, the ethylene and the MFBA each polymerized into the polymer backbone. In this way, the present ethylene-based polymer is structurally distinct compared to a polyethylene with a functional coagent grafted pendant to the polymer chain.

Polymerization conditions include polymerization utilizing one, two, or more free-radical indicators. Nonlimiting examples of suitable free-radical initiators include organic peroxides, cyclic peroxides, diacyl peroxides, dialkyl peroxides, hydroperoxides, peroxycarbonates, peroxydicarbonates, peroxyesters, peroxyketals, t-butyl peroxy pivalate, di-t-butyl peroxide, t-butyl peroxy acetate, t-butyl peroxy ethylhexanoate, and t-butyl peroxy-2-hexanoate, and combinations thereof. In an embodiment, these organic peroxy initiators are used in an amount from 0.001 wt % to 0.2 wt %, based upon the weight of polymerizable monomers.

In a further embodiment, the free-radical initiator includes at least one peroxide group incorporated in a ring structure. Examples of such initiators include, but are not limited to, TRIGONOX 301 (3,6,9-triethyl-3,6,9-trimethyl-1,4,7-triperoxonaan) and TRIGONOX 311 (3,3,5,7,7-pentamethyl-1,2,4-trioxepane), both available from Akzo Nobel, and HMCH-4-AL (3,3,6,6,9,9-hexamethyl-1,2,4,5-tetroxonane) available from United Initiators.

For the polymerization conditions, the polymerization reactor includes a reactor configuration including a tubular reactor, and/or an autoclave reactor, and/or a continuously stirred tank reactor.

In an embodiment, the polymerization takes place in a reactor configuration that includes at least one tubular reactor.

In an embodiment, the polymerization takes place in a reactor configuration that includes at least one autoclave reactor.

In an embodiment, the process includes reacting ethylene with from 5 mol ppm to 2000 mol ppm MFBA based on the amount of added ethylene to the polymerization reactor, and forming an ethylene-MFBA copolymer having a melt strength that is from 10% to 200% greater than the melt strength of a baseline ethylene homopolymer. As used herein, the term “mol ppm” is the relationship of one mole of ethylene for 1×10⁻⁶ moles of MFBA. A “baseline ethylene homopolymer,” as used herein, is an ethylene homopolymer made under the same polymerization conditions as the polymerization conditions for producing the ethylene-MFBA copolymer, the baseline ethylene homopolymer having the same or substantially the same melt index (I2±0.5 g/10 min) as the ethylene-MFBA copolymer.

In an embodiment, a conventional chain transfer agent (CTA) is used to control molecular weight. One or more CTAs are added during the polymerization process. Non-limiting examples of suitable CTAs include propylene, isobutane, n-butane, 1-butene, methyl ethyl ketone, acetone, ethyl acetate, propionaldehyde, ISOPAR (ExxonMobil Chemical Co.), methanol, and isopropanol. In an embodiment, the amount of CTA used in the process is from 0.03 weight percent to 10 weight percent of the total reaction mixture.

In an embodiment, the process includes a process recycle loop to improve conversion efficiency.

In an embodiment, the polymerization takes place in a tubular reactor. The tubular reactor can be a single zone tubular reactor or a multi zone tubular reactor. In a further embodiment, the tubular reactor is a multi-zone tubular reactor. A multi-zone tubular reactor includes alternate locations of feeding fresh ethylene to control the ethylene to CTA ratio and therefore control polymer properties. Fresh ethylene monomer is simultaneously added in multiple locations to achieve the desired ethylene monomer to chain transfer ratio. In a similar way, addition of fresh CTA addition points are selected to control polymer properties. Fresh CTA is simultaneously added in multiple locations to achieve the desired CTA to ethylene monomer ratio. Likewise, the addition points and the amount of fresh MFBA are controlled to control gel formation while maximizing the desired property of increased melt strength and performance in targeted applications. Fresh MFBA can be simultaneously added in multiple locations to achieve the desired branching agent to ethylene monomer ratio. The use of a MFBA to broaden molecular weight distribution and to increase the melt strength of the polymer will put further requirements on the distribution of the CTA and the MFBA along a reactor system in order to achieve the desired change in product properties without, or minimizing, potential negative impacts such as gel formation, reactor fouling, process instabilities, and minimizing the amount of MFBA. Nonlimiting examples of suitable multi zone tubular reactors are described in WO2013059042 and WO2013078018, the content of each reference incorporated by reference herein.

In an embodiment, the polymerization takes place in a multi reactor system, where an autoclave reactor precedes the tubular reactor. The addition points and amounts of fresh ethylene, fresh CTA, and fresh MFBA are controlled to achieve the desired ratios of CTA to ethylene monomer and MFBA to ethylene monomer in the feeds to and or in the reaction zones.

In an embodiment, the MFBA is fed through a compression stage directly into the reaction zone or directly into the feed to the reaction zone. The choice of feed point into the reaction and/or a reaction zone depends on several factors, including, but not limited to, the solubility of the MFBA in pressurized ethylene and/or solvent, the condensation of the MFBA in pressurized ethylene, and/or fouling by premature polymerization of the MFBA in the pre-heater used to heat the reactor contents prior to injection of initiator.

In an embodiment, the MFBA is fed directly into the reaction zone or directly into the feed to the reaction zone.

In an embodiment, the MFBA is fed only to reaction zone 1.

In an embodiment, the ethylene fed to the first reaction zone is from 10 percent to 100 percent of the total ethylene fed to the polymerization. In a further embodiment, the ethylene fed to the first reaction zone is from 20 percent to 80 percent, further from 25 percent to 75 percent, further from 30 percent to 70 percent, further from 40 percent to 60 percent, of the total ethylene fed to the polymerization.

In an embodiment, the process takes place in a reactor configuration that comprises at least one tubular reactor. In a further embodiment, the maximum temperature in each reaction zone is from 200° C. to 350° C., further from 220° C. to 325° C., further from 225° C. to 300° C.

In an embodiment, the polymerization pressure at the first inlet of the reactor is from 800 bar to 3600 bar, or from 1500 bar to 3400 bar, or from 2000 bar to 3200 bar.

In an embodiment, the ratio of “the concentration of the CTA in the feed to reaction zone i” to “the concentration of the CTA in the feed added to reaction zone 1” is greater than, or equal to, 1.

In an embodiment, the ratio of “the concentration of the CTA in the feed to reaction zone i” to “the concentration of the CTA in the feed added to reaction zone 1” is less than 1, or less than 0.8, or less than 0.6, or less than 0.4.

In an embodiment the number of reaction zones is from 3 to 6.

Non-limiting examples of ethylene monomer used for the production of the ethylene-based polymer include purified ethylene, which is obtained by removing polar components from a loop recycle stream, or by using a reaction system configuration, such that only fresh ethylene is used for making the inventive ethylene-based polymer. Further examples of ethylene monomer include ethylene monomer from a recycle loop.

In an embodiment, the process includes reacting a termonomer with the ethylene and the MFBA under the polymerization conditions. The process includes forming an ethylene-based polymer composition composed of units of ethylene monomer, units of the MFBA, and units of one or more termonomers. Non-limiting examples of suitable termonomers include α-olefins, acrylates, methacrylates, vinyl acetate, vinyl trimethoxysilane and anhydrides, each having no more than 20 carbon atoms. The α-olefin termonomers may have from 3 to 10 carbon atoms, or in the alternative, the α-olefin termonomers may have from 3 to 8 carbon atoms or 4 to 8 carbon atoms. Exemplary α-olefin termonomers include, but are not limited to, propylene, 1-butene, 1-pentene, 1-hexene, 1-heptene, 1-octene, 1-nonene, 1-decene, and 4-methyl-1-pentene.

In an embodiment, the process includes reacting ethylene, the MFBA (and optional termonomer) in the presence of one or more optional additives under the polymerization conditions to form the ethylene-based polymer composition. Non-limiting examples of suitable additives include stabilizers, plasticizers, antistatic agents, pigments, dyes, nucleating agents, fillers, slip agents, fire retardants, processing aids, smoke inhibitors, viscosity control agents and anti-blocking agents. The composition may, for example, include 0 wt %, or from greater than 0 wt %, to less than 30 percent of the combined weight of one or more additives, based on the weight of the composition. The composition with MFBA copolymerized with ethylene and one or more optional additives is hereafter interchangeably referred to as “MFBA(PE).”

In an embodiment the MFBA(PE) is treated with one or more stabilizers, for example, antioxidants, such as IRGANOX 1010, IRGANOX 1076 and IRGAFOS 168.

### 2. Polymer

The present disclosure provides an ethylene-based polymer composed of units of ethylene and units of MFBA (interchangeably referred to as “MFBA(PE)”). The MFBA(PE) is formed by reacting the MFBA and the ethylene (and optional termonomer(s)) under polymerization conditions as disclosed above. The MFBA(PE) includes units of ethylene; (optionally units of termonomer) and units of the multifunctional branching agent (MFBA) having

(A) three or more carbon-carbon double bonds with the provisos
(1) that the MFBA is not a polymer of butadiene, and
(2) the MFBA does not contain an acrylate group or a methacrylate group,

(B) a total reactivity, R, greater than 3 and less than 40, (3<R<40) wherein R is determined with the following formula (I)

$$R = {\sum }_{{j = 1}^{}}^{p} \frac{{n}_{j}}{{r}_{1 , j}} = \frac{{n}_{1}}{{t}_{1 , 1}} + \frac{{n}_{2}}{{t}_{1 , 2}} + \frac{{n}_{3}}{{t}_{1 , 3}} + … \qquad formula ( I )$$

wherein

j=index of summation,

p=the number of different types of carbon-carbon double bonds in the MFBA,

nⱼ=the number of each carbon-carbon double bond of type j in the molecule, and

r_{1,j}=the relative reactivity ratio (RRR) of ethylene to the carbon-carbon double bond j.

Bounded by no particular theory, the MFBA increases the melt strength of the formant ethylene-based polymer composition. Under polymerization conditions, one, or two, or three, or more carbon-carbon double bonds in the MFBA react with (bond with) the growing chain(s) of forming ethylene-based polymer, to become part of the polyethylene chain(s). The ethylene-based polymer has units derived from ethylene and units derived from the MFBA, wherein the units of derived from ethylene constitute a majority amount (wt %) of the units present in the polymer. In other words, the ethylene-based polymer includes ethylene monomer and MFBA comonomer, the ethylene and the MFBA each polymerized into the polymer backbone. In this way, the present ethylene-based polymer is structurally distinct compared to a polyethylene with a functional coagent grafted pendant to the polymer chain. The ethylene-MFBA copolymer composition is interchangeably referred to as “MFBA(PE).”

In an embodiment, the MFBA is selected from (D^{Vi})₄, bisallylmaleate, polyisoprene, polymyrcene, polyfarnesene, and combinations thereof.

In an embodiment, the MFBA is (D14.

In an embodiment, the MFBA is bisallylmaleate.

In an embodiment, the MFBA(PE) includes, in polymerized form, from 95 wt %, or 96 wt %, or 97 wt %, or 98 wt % to 99 wt %, or 99.5 wt %, or 99.8 wt %, or 99.9 wt %, or 99.95 wt %, or 99.99 wt % of ethylene, and a reciprocal amount of MFBA, or from 5.0 wt %, or 4.0 wt %, or 3.0 wt %, or 2.0 wt % to 1.0 wt %, or 0.5 wt %, or 0.2 wt %, or 0.1 wt %, or 0.05 wt %, or 0.01 wt % of MFBA. Weight percent is based on total weight of the MFBA(PE). In a further embodiment, the MFBA(PE) includes, in polymerized form, from 95 wt % to 99.99 wt %, or from 96 wt % to 99.95 wt %, or from 97 wt % to 99.9 wt %, or from 98 wt % to 99.8 wt % of ethylene, and the MFBA is present in an amount from 5.0 wt % to 0.01 wt %, or from 4.0 wt % to 0.05 wt %, or from 3.0 wt % to 0.1 wt %, or from 2.0 wt % to 0.2 wt %.

In an embodiment, the MFBA(PE) has a density from 0.915 g/cc to 0.935 g/cc.

In an embodiment, the MFBA(PE) has a melt index (12) from 0.05 g/10 min, or 0.5 g/10 min, or 1.0 g/10 min, or 5.0 g/10 min, or 10 g/10 min, or 20 g/10 min, or 30 g/10 min, or 40 g/10 min to 50 g/10 min, or 60 g/10 min, or 70 g/10 min, or 100 g/10 min, or 1000 g/10 min. In a further embodiment, the MFBA(PE) has a melt index (12) from 0.15 g/10 min to 80 g/10 min, or from 0.5 g/10 min to 70 g/10 min, or from 1.0 g/10 min to 60 g/10 min, or from 5.0 g/10 min to 50 g/10 min, or from 10 g/10 min to 40 g/10 min, or from 20 g/10 min to 30 g/10 min. In yet a further embodiment, the MFBA(PE) has a melt index from 0.1 g/10 min to 4.5 g/10 min, or from 0.5 g/10 min to 4.0 g/10 min.

In an embodiment, the ethylene-based polymer composition includes ethylene monomer the MFBA, and one or more termonomers. Non-limiting examples of termonomers include α-olefins, acrylates, methacrylates, acrylic acid, methacrylic acid, vinyl acetate, vinyl trimethoxy silane and anhydrides, each having no more than 20 carbon atoms. The α-olefin termonomers may have from 3 to 10 carbon atoms, or in the alternative, the α-olefin termonomers may have from 3 to 8 carbon atoms or 4 to 8 carbon atoms. Exemplary α-olefin termonomers include, but are not limited to, propylene, 1-butene, 1-pentene, 1-hexene, 1-heptene, 1-octene, 1-nonene, 1-decene, and 4-methyl-1-pentene.

In an embodiment, the ethylene-based polymer composition includes one or more optional additives. Non-limiting examples of suitable additives include stabilizers, plasticizers, antistatic agents, pigments, dyes, nucleating agents, fillers, slip agents, fire retardants, processing aids, smoke inhibitors, viscosity control agents and anti-blocking agents. The composition ethylene-based polymer may, for example, include from 0 wt %, or greater than 0 wt %, to less than 10 wt % of the combined weight of one or more additives, based on the weight of the ethylene-based polymer composition.

In an embodiment the MFBA(PE) is treated with one or more stabilizers, for example, antioxidants, such as IRGANOX 1010, IRGANOX 1076 and IRGAFOS 168.

The MFBA(PE) may include a combination of two or more embodiments as described herein.

The present disclosure also provides an article comprising at least one component formed from the MFBA(PE), described herein.

In an embodiment, the article is a coating of a film.

In an embodiment, the article is a coating.

In an embodiment, the article is a film.

The article may include a combination of two or more embodiments as described herein.

### 3. Applications

The MFBA(PE) of the present disclosure may be employed in a variety of conventional thermoplastic fabrication processes to produce useful articles, including monolayer and multilayer films; molded articles, such as blow molded, injection molded, or rotomolded articles; coatings; fibers; and woven or non-woven fabrics.

The present MFBA(PE) may be used in a variety of films, including but not limited to, clarity shrink films, collation shrink films, cast stretch films, silage films, stretch hood, sealants, and diaper backsheets. Other suitable applications include, but are not limited to, wires and cables, gaskets and profiles, adhesives, footwear components, and auto interior parts.

Applicant discovered that addition of MFBA during polymerization of ethylene leads to increased melt strength of the LDPE resin for the same MI when compared to the LDPE resin made under the same polymerization conditions and without addition of MFBA.

By way of example, and not limitation, some embodiments of the present disclosure will now be described in detail in the following examples.

### EXAMPLES

Materials used in the examples are set forth in Table 1 below.

TABLE 1

| Commercial name | Description | Source |
|---|---|---|
| Bisallyl maleate | Multi functional | Sigma-Aldrich |
| | branching agent | |
| (D^{Vi})₄ | Multi functional | Alfa Aesar |
| | branching agent | |
| Isopar E | solvent | Exxon Mobil |
| TPA | tert-butyl peroxy | Akzo-Nobel |
| | acetate - initiator | |
| TPO | tert-butyl peroxy | Akzo Nobel |
| | ethylhexanoate - initiator | |
| Propylene | chain transfer agent | Dow Inc. |

### Example 1: Bisallyl Maleate (BAIIM) as a Multifunctional Branching Agent

The polymerization was carried out in a continuously stirred tank reactor. Four electric heater bands were used to heat and/or cool the reactor to 220° C. The reactor pressure was about 2000 bar. Propylene was used as a chain transfer agent (CTA) in an amount to control the final polymer melt index (MI) at 4.0. Ethylene and propylene were fed to the top of the reactor by the agitator shaft. TPO and TPA diluted in lsopar E were injected into one side of the reactor to initiate the reaction to maintain the total ethylene conversion at ˜12%. Bisallyl maleate, also diluted in lsopar E, was fed into a separate injector on the side of the reactor. The reactor residence time was about 1.5 minutes. A single outlet on the bottom reactor contained all unreacted reactants and polymer. Polymer was separated from the remaining reactants by atomization, depressurizing the stream to about 1 bar and simultaneously cooling the stream to ambient temperatures. Polymer was then collected in powder form.

The structure of bisallyl maleate is shown by reference numeral 10 in FIG. 1. Bisallyl maleate contains three C—C double bonds, does not contain acrylate or methacrylate groups, and is not a product of butadiene polymerization and thereby fulfills parameter (A) for MFBA. Bisallyl maleate contains two different types of C—C double bonds (p=2). Bisallyl maleate has one internal maleate double bond n₁=1 which has a reactivity ratio of 0.2. Bisallyl maleate has 2 terminal vinyl groups n₂=2 which have a reactivity ratio of 3.1. The R value is therefore calculated as 5.6. Thus, bisallyl maleate fulfills the parameter (A) and parameter (B) (formula 1) and is therefore an MFBA as defined herein.

The data from the inventive examples with bis-allyl-maleate (BAIIM) as the MFBA are shown in Table 4. The addition from 30 mol ppm to 93 mol ppm bis-allyl maleate increases the melt strength (“MS”) for ethylene/BAIIM copolymers compared to the melt strength of the baseline ethylene homopolymer (comparative sample or “CS”) produced under the same polymerization conditions at the same, or substantially the same, I2. The baseline ethylene homopolymer has an I2 value of 4.00 g/10 min and 13.84 cN melt strength. Ethylene/BAIIM copolymers in IE1, IE2, and IE3 have respective I2/melt strength values of: IE1 3.67/16.36 cN (18% melt strength increase over baseline), IE2 4.0/17.63 (27% melt strength increase over baseline), and IE3 3.99/17.09 cN (23% melt strength increase over baseline).

TABLE 4
Results using bis-allyl maleate as the MFBA

| | | CS | | | |
|---|---|---|---|---|---|
| | | Propylene | IE1 | IE2 | IE3 |
| | | Baseline at | 30 mol | 60 mol | 90 mol |
| | | 220° C. | ppm BAIIM | ppm BAIIM | ppm BAIIM |
| C2 Feed Flow | lbs/hr | 11.96 | 11.95 | 12.31 | 12.04 |
| Reactor Pressure | psig | 24860 | 25196 | 25520 | 25477 |
| Reactor Average Temp | ° C. | 220 | 222 | 225 | 220 |
| Ethylene Conversion | wt % | 11.79 | 12.50 | 11.92 | 12.57 |
| BAIIM Reactor | mol ppm | 0.00 | 33.63 | 58.65 | 92.83 |
| Concentration | | | | | |
| Solvent | | Isopar E | Isopar E | Isopar E | Isopar E |
| Initiator 1 | | TPA | TPA | TPA | TPA |
| Amt of initiator 1 | mol ppm | 14.65 | 12.09 | 9.96 | 12.13 |
| Initiator 2 | | TPO | TPO | TPO | TPO |
| Amt of Initiator 2 | mol ppm | 14.65 | 12.29 | 9.9.6 | 12.13 |
| CTA | | Propylene | Propylene | Propylene | Propylene |
| CTA Reactor | mol ppm | 15563 | 22209 | 22489 | 22250 |
| Concentration | | | | | |
| I2 | (g/10 min) | 4.00 | 3.67 | 4.00 | 3.99 |
| Melt strength | (CN) | 13.84 | 16.36 | 17.63 | 17.09 |
| % Increase in MS | % | NA | 18 | 27 | 23 |
| vs. baseline | | | | | |

### Example 2: (D^{Vi})₄ as a Multifunctional Branching Agent

The polymerization was carried out in a continuously stirred tank reactor run adiabatically. The reactor pressure was about 2000 bar. Propylene was used as a chain transfer agent (CTA) in an amount to control the final polymer melt index at ˜4 g/10 min. Ethylene and propylene were fed to the top of the reactor by the agitator shaft at a temperature of 60° C. TPO diluted to 1 wt % in mineral spirits was injected into one side of the reactor to initiate the reaction to maintain the reactor temperature at 220° C. (D^{Vi})₄, also diluted in mineral spirits, was fed into a separate injector on the side of the reactor. The reactor residence time was about 1.5 minutes. A single outlet on the bottom reactor contained all unreacted reactants and polymer. Polymer was separated from the remaining reactants by devolatization in a low pressure separator operating at 200 ° C. and 15 bar, the resulting molten polymer was then extruded through a pelletizer and collected.

The structure of (D^{Vi})₄ is provided in Table 2. (D^{Vi})₄ does not contain acrylate or methacrylate groups and (D^{Vi})₄ is not a product of butadiene polymerization. (D^{Vi})₄ contains one type of carbon-carbon double bond (p=1). (D^{Vi})₄ has four of these double bonds per molecule n₁=4 which have a reactivity ratio of 0.4. The R value is therefore calculated as 10. Thus (D^{Vi})₄ fulfills parameter (A) and parameter (B) (formula 1) and is therefore an MFBA as defined herein.

The data from the inventive examples with (D^{Vi})₄ as the MFBA are shown in Table 5 (below). The addition from 40 mol ppm to 130 mol ppm (D^{Vi})₄ increases the melt strength for ethylene/(D^{Vi})₄ copolymers compared to the melt strength of the baseline ethylene homopolymer produced under the same polymerization conditions at the same, or substantially the same, I2. The baseline ethylene homopolymer with no (D^{Vi})₄ has a melt strength of 3.3 cN and the ethylene/(D^{Vi})₄ copolymers each have a melt strength greater than 6 cN.

As shown in Table 5, the baseline ethylene homopolymer has an I2 value of 4.15 g/10 min and 3.32 cN melt strength. Ethylene/(D^{Vi})₄ copolymers in 1E4, 1E5, and 1E6 have respective I2/melt strength values of: IE4 3.69/7.65 cN (130% melt strength increase over baseline), IE5 3.79/6.33 (91% melt strength increase over baseline), and IE6 3.68/8.37 (150% melt strength increase over baseline).

TABLE 5
Results using (D^{VI})₄as the MFBA

| | | CS | | | |
|---|---|---|---|---|---|
| | | Propylene | IE4 | IE5 | IE6 |
| | | Baseline at | 40 mol | [symbol] 80 mol | 130 mol |
| | | 220° C. | ppm (D^{Vi})₄ | ppm (D^{Vi})₄ | ppm (D^{Vi})₄ |
| C2 Feed Flow | lbs/hr | 25.0 | 25.1 | 24.9 | 25.0 |
| Reactor Pressure | psig | 28,000 | 28,000 | 28,000 | 28,000 |
| Reactor Average Temp | ° C. | 220.0 | 219.9 | 219.9 | 219.7 |
| Feed Temperature | ° C. | 60.0 | 60.0 | 59.9 | 60.2 |
| ViD4 Reactor | mol ppm | 0 | 40 | 80 | 130 |
| Concentration | | | | | |
| CTA | | propylene | propylene | propylene | propylene |
| CTA Reactor | mol ppm | 24,700 | 26,200 | 29,910 | 32,476 |
| Concentration | | | | | |
| I2 | (g/10 min) | 4.15 | 3.69 | 3.79 | 3.68 |
| Melt strength | (CN) | 3.32 | 7.65 | 6.33 | 8.37 |
| % Increase in MS | % | NA | 130 | 91 | 150 |
| vs. baseline | | | | | |

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
providing a multifunctional branching agent (MFBA) having
A) three or more carbon-carbon double bonds with the provisos
(1) that the MFBA is not a polymer of butadiene, and
(2) the MFBA does not contain an acrylate group or a methacrylate group,
B) a total reactivity, R, greater than 3 and less than 40, (3<R<40) wherein R is determined with the following formula (I)
$$R = {\sum }_{j = 1}^{p} \frac{{n}_{j}}{{r}_{1 , j}} = \frac{{n}_{1}}{{r}_{1 , 1}} + \frac{{n}_{2}}{{r}_{1 , 2}} + \frac{{n}_{3}}{{r}_{1 , 3}} + … \qquad formula ( I )$$
wherein
j=index of summation,
p=the number of different types of carbon-carbon double bonds j in the molecule,
nⱼ=the number of each carbon-carbon double bond of type j in the molecule, and
r_{1,j}=the relative reactivity ratio (RRR) of ethylene to the carbon-carbon double bond j;
reacting the MFBA with ethylene under polymerization conditions; and
forming an ethylene-based polymer composition comprising units of ethylene and units of the MFBA.

2. The process of claim 1 comprising reacting ethylene and MFBA in a tubular reactor; and
forming an ethylene-based polymer composition comprising units of ethylene and units of the MFBA.

3. The process of claim 1 comprising reacting ethylene and the MFBA in an autoclave reactor; and
forming an ethylene-based polymer composition comprising units of ethylene and units of the MFBA.

4. The process of any of claims 1-3 comprising reacting ethylene with an MFBA selected from the group consisting of (D^{Vi})₄, bisallylmaleate, polyisoprene, polymyrcene, polyfarnesene, and combinations thereof; and
forming an ethylene-based polymer composition.

5. The process of any of claims 1-4 comprising reacting a termonomer with the ethylene and the MFBA; and
forming an ethylene-based polymer composition comprising units of ethylene, units of the MFBA, and units of the termonomer.

6. An ethylene-based polymer composition comprising:
units of ethylene; and
units of a multifunctional branching agent (MFBA) having
(A) three or more carbon-carbon double bonds with the provisos
(1) that the MFBA is not a polymer of butadiene, and
(2) the MFBA does not contain an acrylate group or methacrylate group,
(B) a total reactivity, R, greater than 3 and less than 40, (3<R<40) wherein R is determined with the following formula (I)
$${\sum }_{j = 1}^{p} \frac{{n}_{j}}{{r}_{1 , j}} = \frac{{n}_{1}}{{r}_{1 , 1}} + \frac{{n}_{2}}{{r}_{1 , 2}} + \frac{{n}_{3}}{{r}_{1 , 3}} + … \qquad formula ( I )$$
wherein
j=index of summation,
r₁ⱼ=the relative reactivity ratio (RRR) of ethylene to the carbon-carbon double bond j; and
optional units of a termonomer selected from the group consisting of α-olefin, acrylate, methacrylate, vinyl acetate, and vinyltrimethoxysilane.

7. The ethylene-based polymer composition of claim 6 wherein the MFBA is selected from the group consisting of (D^{Vi})₄, bisallylmaleate, polyisoprene, polymyrcene, polyfarnesene, and combinations thereof.

8. The ethylene-based polymer composition of claim 6 comprising units of a termonomer.

9. An article composed of the ethylene-based polymer composition of claim 6.
